(19) United States
(12) Patent Application Publication
(10) Pub. No.: US 2009/0105892 A1
(43) Pub. Date: Apr. 23, 2009

(54) TELEMETRY ANALYSIS SYSTEM NETWORKED DATA ACQUISITION SYSTEM

(76) Inventors: Ryan J. Draughon, Dallas, TX (US); Tony A. Smith, Dallas, TX (US)

Correspondence Address: WILLIAMS, MORGAN & AMERSON, 10333 RICHMOND, SUITE 1100, HOUSTON, TX, 77042, US

(21) Appl. No.: 12/252,542

(22) Filed: Oct. 16, 2008

Related U.S. Application Data
(60) Provisional application No. 60/981,387, filed on Oct. 19, 2007.
(60) Provisional application No. 60/981,698, filed on Oct. 22, 2007.

(51) Int. Cl. G06F 17/00

(52) U.S. Cl. 701/3

(57) ABSTRACT

The present invention is, in its various aspects and embodiments, a method and apparatus for use in acquiring telemetry regarding an airborne vehicle. In one aspect, the processing of acquired telemetry data is distributed to the points of acquisition rather than at the host station. In another aspect, various points on the telemetry acquisition system employ a common network interface through which the telemetry acquisition stations communicate acquired telemetry data to the control station. In still another aspect, the invention also includes a TDP/IP protocol for communicating between stations. Still other aspects and embodiments are disclosed and claimed.

The U.S. Government has a paid-up license in this invention and the right in limited circumstances to require the patent owner to license others on reasonable terms as provided for by the terms of DAAH01-03-C-0164 awarded by the United States Department of Defense.

The earlier effective filing date of U.S. Provisional Application Serial No. U.S. 60/981,387, entitled “TASNET Data Acquisition System”, and filed Oct. 19, 2007, in the name of the inventors Ryan J. Draughon and Tony A. Smith (Attorney Docket No. 2063.014690/MC-825A), is hereby claimed under 35 U.S.C. §120 for all common subject matter. This application is hereby incorporated by reference for all purposes as if set forth verbatim herein.

The earlier effective filing date of U.S. Provisional Application Serial No. U.S. 60/981,698, entitled “TASNET Data Acquisition System”, and filed Oct. 22, 2007, in the name of the inventors Ryan J. Draughon and Tony A. Smith (Attorney Docket No. 2063.014691/MC-825B), is hereby claimed under 35 U.S.C. §120 for all common subject matter. This application is hereby incorporated by reference for all purposes as if set forth verbatim herein.

### BACKGROUND OF THE INVENTION

1. Field of the Invention

The present invention pertains to telemetry acquisition of an airborne vehicle, and, more particularly, to a telemetry acquisition system that in various aspects (1) is modular, (2) employs a uniform system interface, and (3) employs distributed processing of acquired telemetry data.

2. Description of the Related Art

There is a frequent need to acquire telemetry data from high speed airborne vehicles in flight. The instance most familiar in popular culture is the telemetry data streamed from rockets or vehicles to ground stations during space shots. However, many more mundane examples also exist. For example, when a new missile or rocket is under development, test shots of prototypes might be made to test the design. Telemetry data indicating the performance of the vehicle is streamed back to ground stations whereupon it is transmitted to a central location. It can then be analyzed to evaluate the performance of the design during the test.

The present invention is directed to resolving, or at least reducing, one or all of the problems mentioned above.

### SUMMARY OF THE INVENTION

The present invention is, in its various aspects and embodiments, a method and apparatus for use in acquiring telemetry regarding an airborne vehicle. In one aspect, the processing of acquired telemetry data is distributed to the points of acquisition rather than at the host station. In another aspect, various points on the telemetry acquisition system employ a common network interface through which the telemetry acquisition stations communicate acquired telemetry data to the control station. In still another aspect, the invention also includes a TDP/IP protocol for communicating between stations. Still other aspects and embodiments are disclosed and claimed below.

### BRIEF DESCRIPTION OF THE DRAWINGS

The invention may be understood by reference to the following description taken in conjunction with the accompanying drawings, in which like reference numerals identify like elements, and in which:

FIG. 1 depicts one particular embodiment of a telemetry data acquisition system constructed and operated in accordance with the present invention;

FIG. 2 is a block diagram of selected components of the embodiment of FIG. 1 to illustrate certain aspects of the present invention;

FIG. 3-FIG. 4 illustrate different aspects of a common network interface employed in the embodiment of FIG. 1 in accordance with one aspect of the present invention;

FIG. 5 shows selected portions of the hardware and software architecture of a computing apparatus such as may be employed in some aspects of the present invention;

FIG. 6-FIG. 20 illustrate selected aspects of the protocol by which elements of the telemetry data acquisition system of FIG. 1-FIG. 2 communicate;

FIG. 21 illustrates a variation of the telemetry data acquisition system of FIG. 1;

FIG. 22 depicts on particular embodiment of the variation shown in FIG. 21; and

FIG. 23 depicts a second embodiment alternative to that of FIG. 1.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

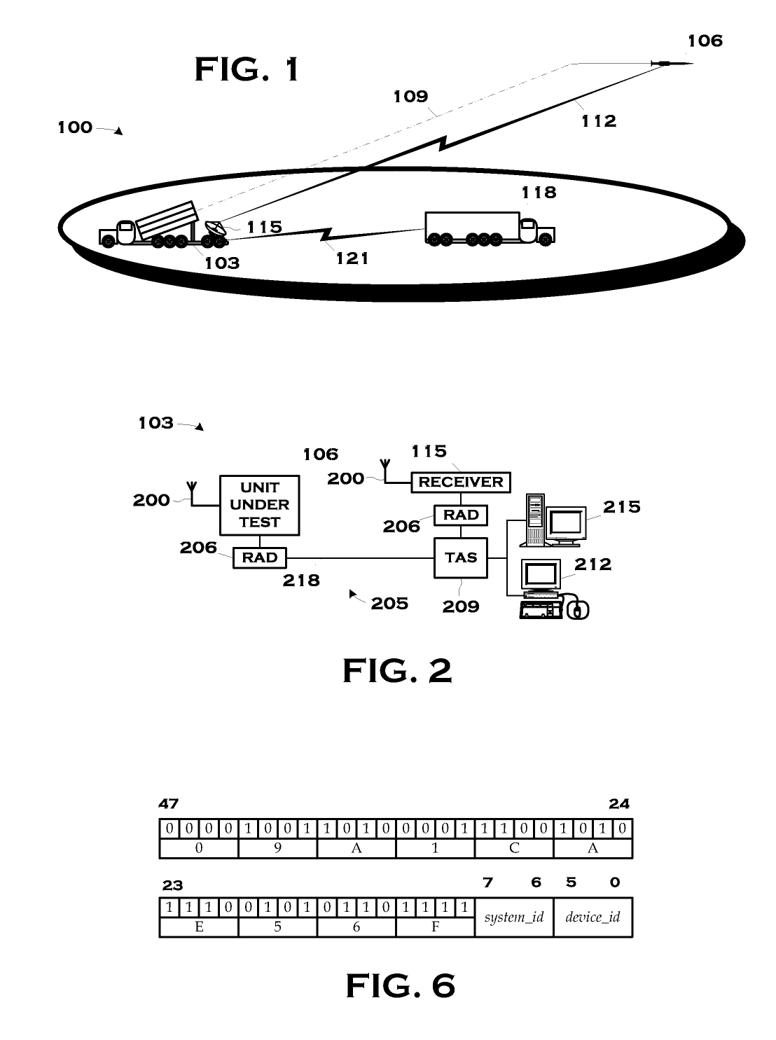

Turning now to the drawings, FIG. 1 illustrates one particular telemetry data acquisition system 100 constructed and operated in accordance with the present invention. The embodiment 100 includes a launcher 103 from which an airborne vehicle 106 is launched. The launcher 103 may also be referred to as a “ground station” or a “launch station.” The airborne vehicle 106 follows a trajectory 109 upon launch. In flight, the airborne vehicle telemeters data (not shown) to the launcher 103 over a communications link 112. In the illustrated embodiment, the launcher 103 includes a receiver 115 that receives the data. The scenario presented in FIG. 1-FIG. 2 is a flight test of a missile, although the invention is not so limited.

Furthermore, although not necessary for the practice of all aspects of the invention, the launcher 103 communicates with another ground station 118 frequently referred to as a “host” or “host station”. The communication is conducted over a communications link 121. The communications link 121 is implemented with optical fibers in the illustrated embodiment, but can be implemented using alternative technologies such as a wireless technology. Communications are performed according to a protocol discussed below.

FIG. 2 illustrates selected portions of the telemetry data acquisition system 100 in a block diagram. FIG. 2 depicts the telemetry data acquisition system 100 prior to launch of the airborne vehicle 106—i.e., the “unit under test” (“UUT”). Note that the airborne vehicle 106 and the receiver 115 each include an antenna 200 through which the communications link 112 is established. In the illustrated embodiment, the communications link 112, shown in FIG. 1, is in the radio frequency (“RF”) band. Each of the antennas 200 is therefore an RF antenna.

The launcher 103 and the receiver 115 each constitute a “node” on a “network” 205 of the telemetry data acquisition system 100. Each of these nodes interacts with the network 205 through a common interface implemented in the remote acquisition devices (“RADs”) 206. The network 205 also includes a telemetry analysis system (“TAS”) 209, a workstation 212, and a server 215.

Although not shown, the RADs 206 of the illustrated embodiment include a launcher interface, a missile interface, a tone generator, and a 4-channel radio frequency (“RF”) receiver. The launcher interface decommutates pulse code modulated (“PCM”) data, 10 BASET Ethernet, and transistor-transistor logic (“TTL”) data streams. The missile interface controls telemetry and flight termination system power, telemetry (“TM”) transmitter, battery squib, and decommutates PCM data. The tone generator controls tones sent to flight termination system (not shown). The 4-channel RF Receiver acquires S-Band RF Data and controls tracking antenna.

In operation, the RAD 206 decodes raw data, reformats the decoded data to a protocol described further below, and routes the reformatted data to the TAS 209 via the communications links 218. The raw data in the illustrated embodiment is PCM data, but can be any kind of telemetry data acquired in conventional practice. The RAD 206 also acquires a Global Positioning System (“GPS”) Inter-range Instrumentation Group (“IRIG”) IRIG-B Time Code for time stamping and provides status data for raw data (presence, loading, lock, etc.). The RAD 206 is a complete firmware/hardware implementation and allows for a cumulative data rate (all RADs) of up to 90 Mbps per TAS 209.

Thus, in accordance with one aspect of the present invention, the processing of the acquired telemetry data is distributed away from the host station to the point of acquisition. The processing transforms the raw stream of acquired data to a decoded stream. This can take several forms. For example, the PCM stream is bit synchronized and decommutated into specific parameters in a RAD 205 and then transferred in tag data pairs via the telemetry acquisition system network (“TASNET”). This is only one example, but in general the processing creates tag data pairs that can be transmitted via the TASNET to the host station. In contrast, conventional practice generally just transfers the data via serial lines to the host station where the data is decoded/processed. All of the processing is done at the host station in conventional practice.

In accordance with another aspect of the present invention, the RADs 206 provide a common network interface for each of the nodes on the network. Conventional practice implements the interface for a given node in an amalgam of hardware components implementing the specific functions of the node. The interfaces accordingly vary greatly depending on the functions of the node. For example, the interface of the launcher 112 and the receiver 115 would have been very different. However, the present invention reduces much of the functionality of those interfaces to firmware programmed into one or more programmable devices (e.g., a field programmable gate array, or “FPGA”).

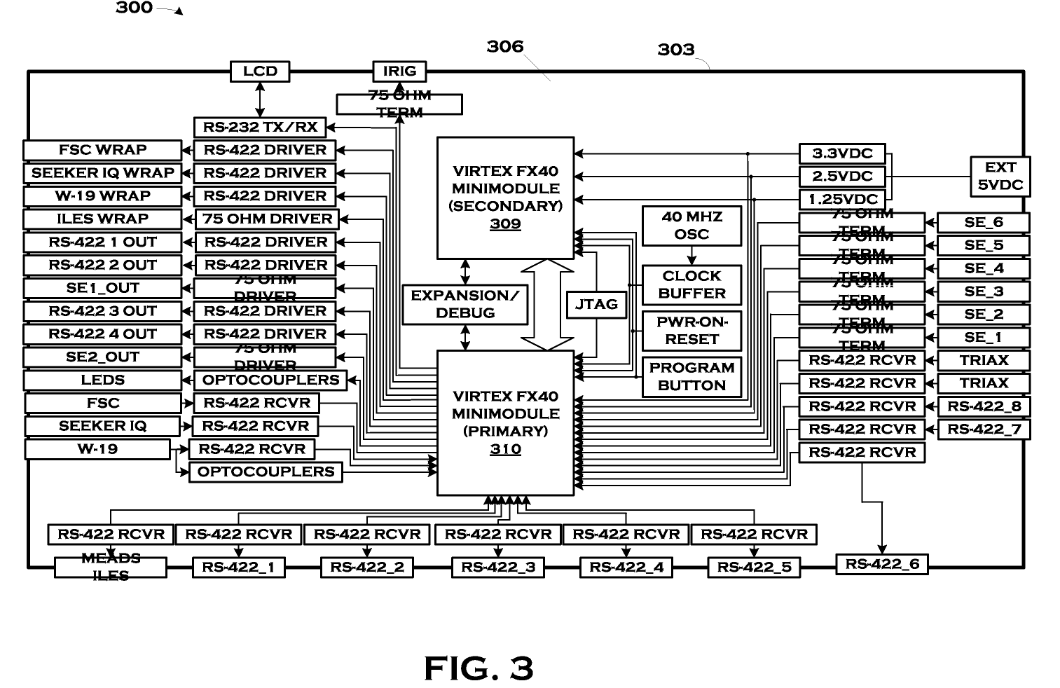

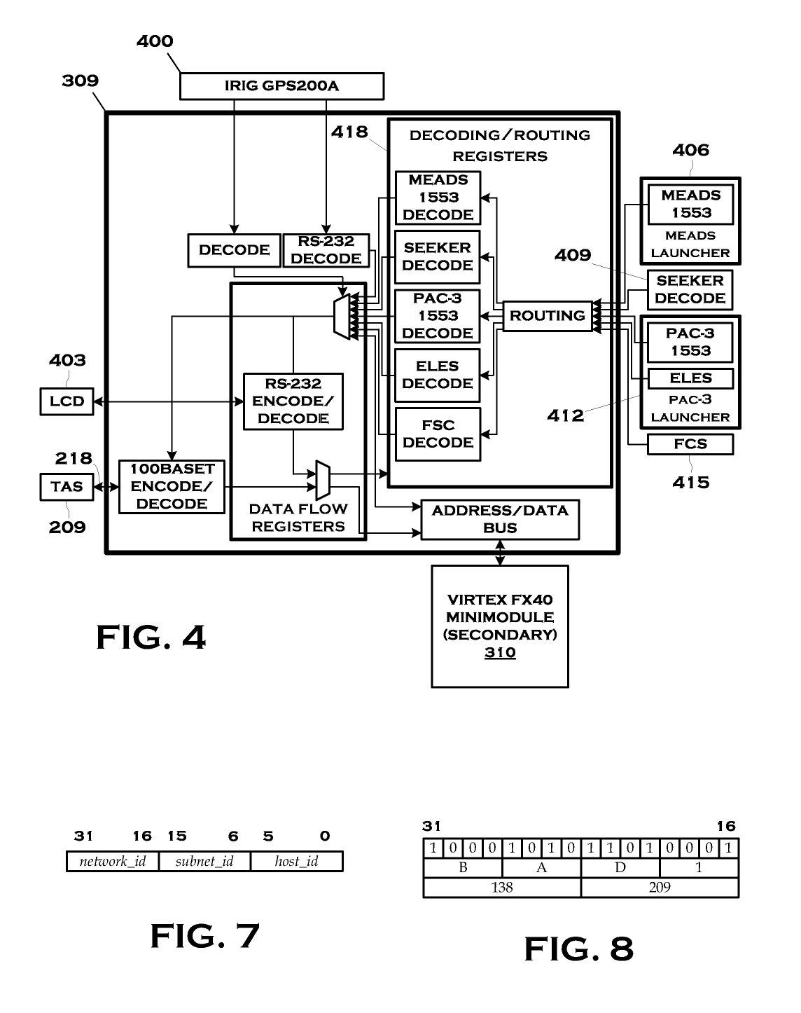

FIG. 3-FIG. 4 illustrate one particular embodiment of a common network interface 300. This is one particular embodiment of an interface used in the launcher 112. FIG. 3 is a block diagram of a populated printed circuit board 303. The board 303 includes 49 RS-422 inputs to different decoders, six TTL inputs, one Ethernet data input, and wrap/self test capability. The perimeter 306 is populated by connectors. Two connectors for EXPANSION/DEBUG and JTAG are located on the interior of the board 303. The remaining devices shown are integrated circuit devices whose function is apparent from their labels in FIG. 3.

The interface 300 includes two field-programmable, gate arrays (“FPGAs”) 309, 310. (Note that alternative embodiments may employ other types of programmable devices). The FPGA 309 is programmed with firmware to implement the data flow shown in the block diagram of FIG. 4. The IRIG GPS200a 400, liquid crystal display (“LCD”) 403 (e.g., of the workstation 212, shown in FIG. 2), TAS 209, MEADS launcher 406, seeker 409, PAC-3 launcher 412, and fire solution computer (“FSC”) 415 are all external to the interface 300. Note that these external sources of data are implementation specific. For instance, as was discussed above, the present invention may be used with not only MEADS or PAC-3 missile systems, but with other systems as well. This implementation specific detail will, in turn, influence the implementation of the decode/routing registers 418.

Thus, the present invention system uses modular telemetry acquisition and processing components that are designed with a common network interface. Data is controlled and transferred between remote locations using standardized networking hardware. This reduces the complex and customized hardware interface of conventional systems with a uniform, common interface by reducing the functionality of the conventional interface to a set of firmware downloaded to a programmable device. The firmware in each node will be customized to emulate the functionality of the conventional interface, but the hardware connections of the interface will be common with and uniform to the hardware of the interfaces for the other nodes. This simplifies all manner of considerations, such as cabling and connection, in the telemetry data acquisition system. For example, this aspect of the invention can reduce the numbering of cables from twelve to two.

Returning now to FIG. 2, the server 215 in the illustrated embodiment is a data access protocol (“DAP”) server and may reside anywhere in the telemetry data acquisition system 100. The server 215 is an implementation specific detail that may not be required in all embodiments. The server 215 provides a single point repository for databases in a hierarchical grouping of configurations, versions, and builds. This facilitates serialization to changes made in databases for configuration management.

In operation, the TAS 209 receives data from the RADs 206 at rates of up to 90 Mbps cumulative and records the data. Command and control data can also be transmitted from the TAS 209 to the RADs 206 where appropriate and when desired. For example, prior to launch, the TAS 209 can communicate with the airborne vehicle 106 through the RAD 206 of the launcher 103. The TAS 209 can load launch information, monitor vehicle status, and even abort the launch if desired. The TAS 209 can also access configuration/database files on the server 215, transmit Current Value Tables (“CVTs”) to the workstation 212, and provide remote login capability for the workstations 212. The TAS 209 furthermore includes an onboard programmable FPGA providing modularity in the same manner as the FPGAs 309, 310 of the RADs 206.

As those in the art will appreciate, acquired data is typically assembled and displayed to a user (not shown) in a Current Value Table. This is performed in the illustrated embodiment through the workstation 212, as alluded to above. The workstation 212 also provides remote login access to the TAS 209. It can provide the RAD 206 control, data recording, and data processing in addition to data viewing. These functionalities are not strictly necessary to the practice of the invention, and some embodiments may therefore omit the workstation 212. However, most implementations will wish to exploit these capabilities and so will include the workstation 212.

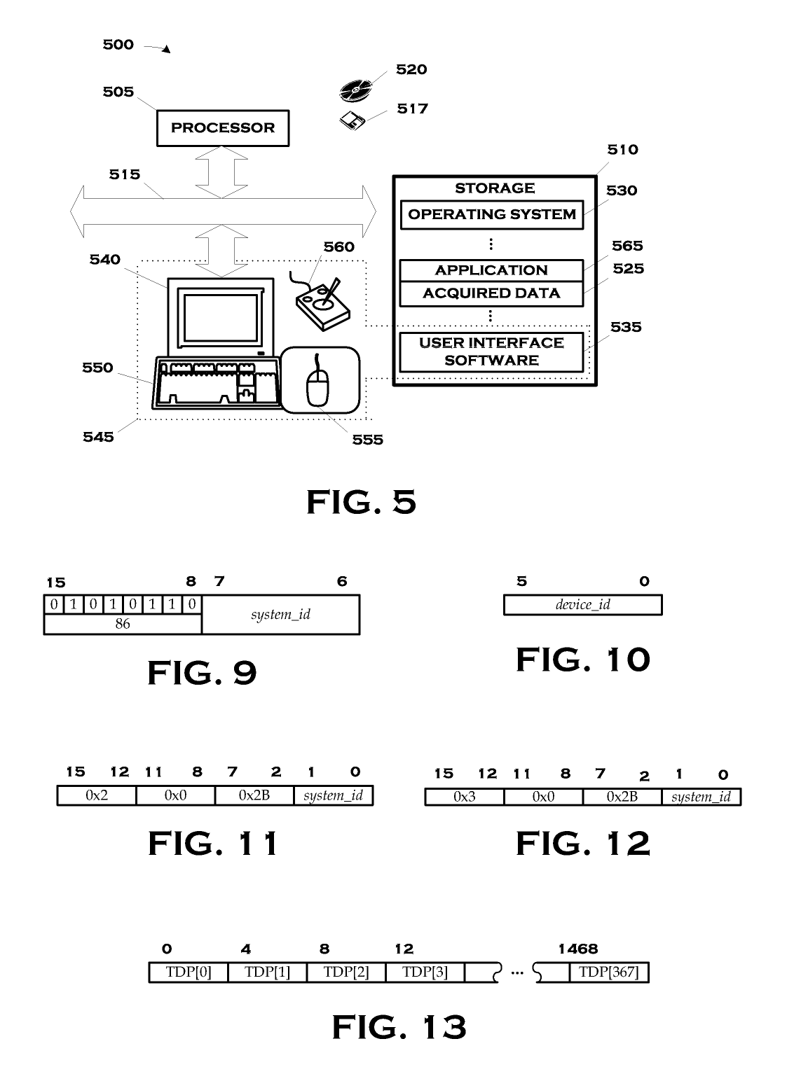

The present invention admits wide variation in the implementation of the computing resources. To help illustrate this variation, consider the block diagram of FIG. 5. FIG. 5 shows selected portions of the hardware and software architecture of a computing apparatus such as may be employed in some aspects of the present invention. The computing apparatus 500 includes a processor 505 communicating with storage 510 over a bus system 515. The storage 510 may include a hard disk and/or random access memory (“RAM”) and/or removable storage such as a floppy magnetic disk 517 and an optical disk 520. The storage 510 is shown encoded with acquired data 525.

The storage 510 is also encoded with an operating system 530, user interface software 535, and an application 565. The user interface software 535, in conjunction with a display 540, implements a user interface 545. The user interface 545 may include peripheral I/O devices such as a keypad or keyboard 550, a mouse 555, or a joystick 560. The processor 505 runs under the control of the operating system 530, which may be practically any operating system known to the art. The application 565 is invoked by the operating system 530 upon power up, reset, or both, depending on the implementation of the operating system 530. The application 565, when invoked, performs the method of the present invention. The user may invoke the application in conventional fashion through the user interface 545.

Within these parameters, the variation mentioned above can accommodate many implementations. For example, in one particular embodiment, the TAS 209 is implemented in a Sun Fire T2000 Server, which typically includes four 10/100/1000 Ethernet ports, three PCI-E slots, two PCI-X slots, eight core 1.0 GHz UltraSPARC T1 processors, an 8 GB DDR2 memory, and is loaded with Solaris 10 and Java Enterprise System software. The Sun Fire T2000 Server is mounted in a 550 chassis including a RAD Ethernet Controller, a real-time Ethernet controller, a data storage Ethernet controller, and a field programmable processor 5 (available from L3 Communications). Similarly, the workstation 212 in the illustrated embodiment is implemented in a Dell Precision Workstation 690, which typically includes two Ethernet ports, multicore Intel Xeon 2.66 GHz Processors, a 1333 FSB, 4 MB L2 Cache, and two 24″ Widescreen Displays. However, alternative embodiments may use alternative computing implementations.

Note that some portions of the detailed descriptions herein are presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

Returning to FIG. 2, the various computing resources therein communicate in accordance with another aspect of the present invention using a TDP/IP protocol, which is an Ethernet-based protocol that will now be disclosed. The protocol employs Media Access Control (“MAC”) and Internet Protocol (“IP”) addressing and a multi-layered messaging protocol. The multi-layered messaging protocol includes a MAC layer, an IP layer, a User Datagram Protocol (“UDP”) layer, and a tagged data pair (“TDP”) layer.

More particularly, this TDP/IP protocol is an application-layer protocol that is customized for the bulk transfer of TDPs (“Tag-Data Pairs”). TDP/IP is built on UDP (a transport-layer protocol) and is designed for the efficient transfer of TDPs with minimal overhead. (This is also why UDP was chosen over TCP as the transport-layer protocol.) A maximum of 368 TDPs may be sent per message in illustrated embodiment. This is due to the fragmentation limit imposed in IP (a network-layer protocol). At 368 TDP/messages, IP packets do not require fragmentation. The RADs 205 will attempt to buffer up 368 messages before transmitting them to the TAS. The TDP/IP protocol is an application-layer protocol built on top of (and is fully compliant with) the other protocol layers (UDP, IP, Ethernet).

Beginning with addressing, as mentioned, the protocol employs an IEEE 802 compliant addressing scheme using MAC addresses that uniquely identify each node on the network. The MAC address format for devices is defined in FIG. 6. The 8-bit field ‘host_id’ is defined below. The MAC address for hosts is undefined. The EtherFIB MAC address follows the specification for device MAC address defined immediately above.

The IP address for hosts and devices follows the IPv4 standard. It is subdivided into a network ID, subnet ID, and host ID, as shown in FIG. 7. The subnet mask for all hosts/devices is 255.255.255.192. The network ID is defined as the most significant 16-bits of the IP address. The value of the network ID field is constant for all hosts and devices, and is defined by FIG. 8. The Subnet ID (SID) is defined as the 10-bits immediately following the Network ID. The most-significant 8-bits of the SID are constant for all hosts and devices, and is defined by FIG. 9. The least-significant 2-bits of the SID are the System ID. The value of the System ID reflects the Ethernet system that the given host/device is operating on. The four systems are named Alpha (00), Bravo (01), Charlie (10), and Delta (11).

Hosts and devices on one system are transparent to those on any other system. In order to accomplish this, the subnet mask of all hosts/devices on the network is set to 255.255.255.192. The Host ID is defined as the least significant 6-bits of the IP address, as shown in FIG. 10. This value is equivalent to the Device ID, a constant value that is unique to each host or device. A list of reserved Device IDs for the illustrated embodiment is supplied in Table 4 below.

Turning now to messaging protocols, communications from the host to a device employ “host-to-device messages.” Host-to-device messages are defined as messages sent from a host system to a device system. These messages may either be broadcast to multiple devices or unicast to a single device. Ethernet encapsulation may be performed according to either IEEE 802.2/802.3 (RFC 1042) or Ethernet (RFC 894) protocols. The Ethernet broadcast address (FF:FF:FF:FF:FF:FF) may be used as the 48-bit destination address. IP encapsulation are performed according to IPv4 with a IP header size of 20 bytes (IP header options are not allowed in host-to-device messages). Host-to-device messages are not be fragmented. The destination IP address may either be set to the system's broadcast IP address or to the IP address of a specific device on the network. System broadcast addresses are shown in Table 1.

TABLE 1
Broadcast IP Addresses

| System | Broadcast Address |
|---|---|
| Alpha | 138.209.86.63 |
| Bravo | 138.209.86.127 |
| Charlie | 138.209.86.191 |
| Delta | 138.209.86.255 |

For host-to-device messages, the UDP source port is defined in FIG. 11, and the UDP destination port is defined in FIG. 12.

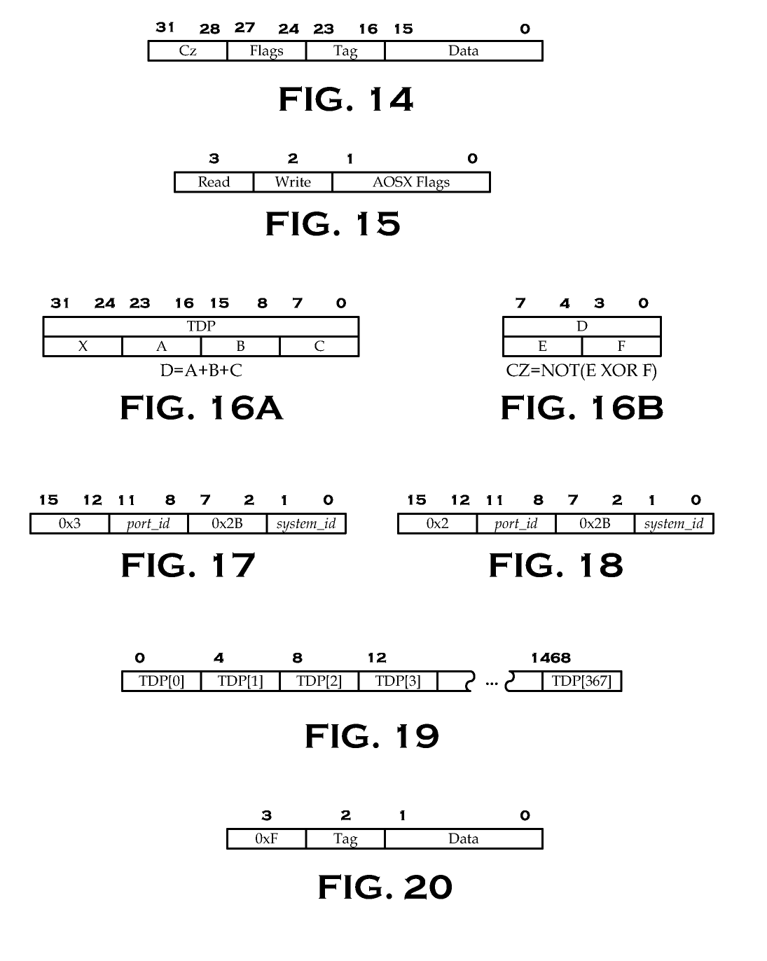

The TDP layer is composed of an array of 32-bit tag-data pairs (TDPs). Each TDP is positioned with the least-significant byte coming first (little-endian). A host-to-device message may contain up to 368 TDPs, as illustrated in FIG. 13. Since each TDP is 4 bytes (32-bits), the maximum length of the TDP array is 1,472 bytes. The structure of a TDP is illustrated in FIG. 14, and is described below. The 8-bit tag field and 16-bit data field are not defined in this document. Please refer to the applicable tag-space definition. The 8-bit tag is extended into a 16-bit tag by prefixing 0xF7. The TDP flags specify the intended method of processing for a given TDP, as defined in FIG. 15. When the read flag is set, the addressed device is requested to respond to the given TDP. If the read flag is set with the write flag, the write will take place before the read.

If the specified tag is invalid or not defined for the given device, the TDP will be ignored and no response will be generated. If the specified tag is write-only, the device will ignore the TDP. When the write flag is set, the addressed device is requested to store the value passed in the TDP data field. If the read flag is set with the write flag, the write will take place before the read. If the specified tag is invalid or not defined for the given device, the TDP will be ignored. If the specified tag is read-only, the device will ignore the TDP. When the write flag is set, the AOSX Flags field specifies the write method, as defined in Table 2. Note that AOSX Flags may not apply to all tags, especially read-only tags, function initiating tags, and other non-register tags. The 4-bit checksum is calculated as shown in FIG. 16A-FIG. 16B. A device will not process a TDP if the checksum is not correct.

TABLE 2
TDPAOSX Flags

| | | |
|---|---|---|
| 1 | 0 | |
| 0 | 0 | AND |
| 0 | 1 | OR |
| 1 | 0 | Set |
| 1 | 1 | XOR |

Communications from devices to hosts employ “device-to-host messages”. Device-to-host messages are defined as messages sent from a device system to a host system. These messages are always broadcast to the entire 86-network, and are never sent directly to a specific host.

Ethernet encapsulation may be performed according to either IEEE 802.2/802.3 (RFC 1042) or Ethernet (RFC 894) protocols. The Ethernet broadcast address (FF:FF:FF:FF:FF:FF) is be used as the 48-bit destination address. The source address is defined above.

IP encapsulation is be performed according to IPv4 with a IP header size of 20 bytes (IP header options are not allowed in device-to-host messages). Device-to-host messages should not be fragmented. The destination IP address should be set to the system's broadcast IP address. System broadcast addresses are shown in Table 3.

TABLE 3
Broadcast IP Addresses

| System | Broadcast Address |
|---|---|
| Alpha | 138.209.86.63 |
| Bravo | 138.209.86.127 |
| Charlie | 138.209.86.191 |
| Delta | 138.209.86.255 |

For device-to-host messages, the UDP source port is defined in FIG. 17, and the UDP destination port is defined in FIG. 18. The ‘port_id’ field is defined by the device and is ignored by the EtherFIB when the message is translated from the 86-network to the 550 Bus.

The TDP layer is composed of an array of 32-bit tag-data pairs (“TDPs”). Each TDP is positioned with the least-significant byte coming first (little-endian). A device-to-host message may contain up to 368 TDPs, as illustrated in FIG. 19. Since each TDP is 4 bytes (32-bits), the maximum length of the TDP array is 1,472 bytes. The structure of a TDP is illustrated in FIG. 20, and is described in the following subsections. The 12-bit tag allows devices to output tags in any family within Generation ‘F’ (Fxxx). The EtherFIB will not translate a TDP onto the 550 Bus if the most significant nibble is not set to 0xF. The 16-bit data field is defined by the device. Refer to the appropriate tag-space definition. The EtherFIB will translate the 16-bit data onto the 32-bit 550 Bus by prefixing 0x0000 (i.e., 0xABCD is translated into 0x0000ABCD).

TABLE 4
List of Device IDs

| ID | Host/Device Name |
|---|---|
| 00-07 | Reserved |
| 08 | eFIB |
| 09 | Storage Box |
| 0A | NooBelo |
| 0B-0F | Reserved |
| 10 | eLIB |
| 11 | eCU |
| 12 | eToneGen |
| 13 | eFAT Test Box |
| 14 | eADC-1 |
| 15 | eADC-2 |
| 16 | eFSC1 |
| 17 | eFSC-2 |
| 18-1F | Reserved |
| 20-2F | Reserved |
| 30 | PC #1 |
| 31 | PC #2 |
| 32 | PC #3 |
| 33 | PC #4 |
| 34 | PC #5 |
| 35 | PC #6 |
| 36 | PC #7 |
| 37 | PC #8 |
| 38 | PC #9 |
| 39 | PC #10 |
| 3A | PC #11 |
| 3B | PC #12 |
| 3C | PC #13 |
| 3D | PC #14 |
| 3E | PC #15 |
| 3F | Reserved |

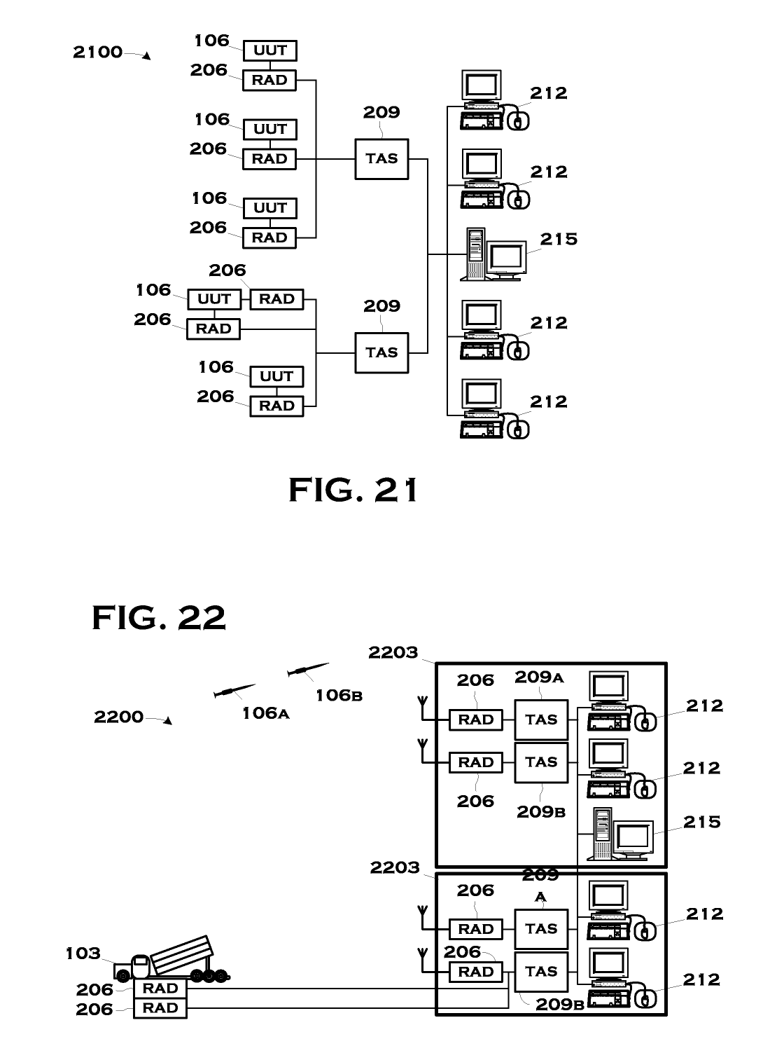

Those in the art having the benefit of the present invention will appreciate that the present invention will typically be used in systems somewhat more complicated than that shown in FIG. 1-FIG. 2. Consider, for example, the telemetry data acquisition system 2100 of FIG. 21. The telemetry data acquisition system 2100 employs multiples TASs 209 with five UUTs 106. The antennae 200 are omitted for the sake of clarity.

FIG. 22 illustrates the principles underlying the telemetry data acquisition system 2100 of FIG. 21 in a more concrete context. More particularly, the telemetry data acquisition system 2200 acquires data regarding the flight and operation of the airborne vehicles 106A, 106B. Both airborne vehicles 106A, 106B are launched from the launcher 103. The telemetry data acquisition system 2200 also includes two ground stations 2203A, 2203B. Each ground station 2203A, 2203B includes a TAS 209A and a TAS 209B, which are configured to receive and analyze information broadcast from the airborne vehicles 106A, 106B, respectively. Thus, the telemetry data acquisition system 2200 includes redundant acquisition and processing.

Returning to FIG. 1, the airborne vehicle 106 is a Patriot Advanced Capability (“PAC”) missile such as is deployed by the United States military. More particularly, the airborne vehicle 106 is a variant known as “PAC-3”. Additional information is publicly available from a number of sources, including on the World Wide Web of the Internet at http://en.wikipedia.org/wiki/MIM-104_Patriot#Patriot_Advanced_Capability_{—}.28PAC.29 (Wikipedia.org entry on the MIM-104 Patriot missile). However, the invention may be used with other types of missile systems such as the multinational Medium Extended Air Defense System (“MEADS”) and the United States' Terminal High Altitude Area Defense (“THAD”), both of which are multinational efforts.

Additional information is publicly available from a number of sources on these and other missile systems. The sources include those on the World Wide Web of the Internet, such as the Wikipedia entries for the MIM-104 Patriot missile, MEADS, and THAAD and the Defense Industry Daily entries on MEADS and THAAD.

As those in the art having the benefit of this disclosure will appreciate, there are many other candidates for implementation of this invention.

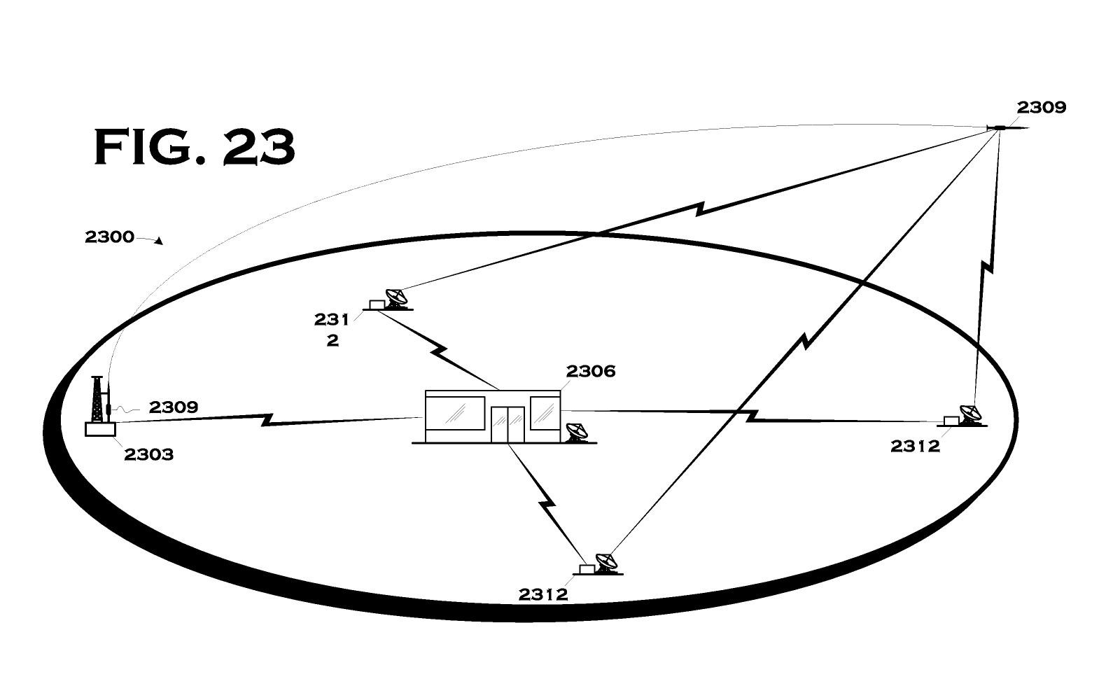

The present invention may also be implemented with respect to airborne vehicles other than missiles and in other contexts than those disclosed above. The embodiments presented above center around telemetering data from a unit under test, and, more particularly, a missile. However, the invention is not so limited. Those in the art having the benefit of this disclosure will appreciate that there may be other circumstances in which the present invention may find application. Consider the telemetry data acquisition system 2300 of FIG. 23, in which the invention is used in the flight of a sounding rocket 2309. Sounding rockets are typically heavily instrumented rockets that are fired for the sole purpose of acquiring data. The data may be remotely sensed atmospheric or earth data or it may indicate

Sounding rockets are well known in the art, and information regarding the design and operation of sounding rockets is widely available. Additional information is publicly available, for example, from the Wikipedia entry “Sounding Rocket”, the “Science and Users Website” for the National Aeronautics and Space Administration (“NASA”) Sounding Rocket Program, and the website for the European Space Agency.

The invention admits wide variation in other aspects of its implementation. For example, in the embodiment of FIG. 1, both the launcher 103 and the host station 106 are mounted on tractor-trailer rigs. This is conventional in the art, but is not necessary to the practice of the invention. In alternative embodiments, some hardware components may be fixed. Consider the telemetry data acquisition system 2300 of FIG. 23, in which both the launch station 2303 and the host station 2306 are fixed. Additional ground stations 2312 are also fixed.

Thus, in various different aspects, the present invention places the signal processing at the source of the data. It then transfers the data in a protocol common to the whole system to a central data processing system for storage and further processing. The network concept allows standardization of networking equipment that is off the shelf and proven to work over long distances. A typical network fiber interface using multimode fiber may be run 10 km. By using single mode fiber the distance may be increased. Another benefit is that as wireless network becomes acceptable for classified use the TASNET may be setup as a wireless network. This significantly reduces setup time and the possibility of broken connections due to things such as vehicles running over cables and such.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for use in acquiring telemetry regarding an airborne vehicle, comprising:
acquiring telemetry data from the airborne vehicle at a point of acquisition;
processing the acquired telemetry data at the point of acquisition; and
transmitting the processed telemetry data to a host station.

2. The method of claim 1, wherein transmitting the processed telemetry data includes transmitting the processed telemetry data over a common network interface.

3. The method of claim 1, wherein acquiring telemetry data includes acquiring guidance data.

4. The method of claim 1, wherein acquiring telemetry includes acquiring sounding data.

5. The method of claim 1, wherein transmitting the processed telemetry data includes transmitting the processed telemetry data using a TDP/IP protocol.

6. The method of claim 1, wherein transmitting the processed telemetry data includes transmitting the processed telemetry data over a networked communications link.

7. The method of claim 6, wherein the networked communications link employs a TDP/IP protocol.

8. The method of claim 1, wherein acquiring the telemetry data at a point of acquisition includes acquiring the telemetry data at a launch station.

9. The method of claim 8, further comprising transmitting a command from the control center to the airborne vehicle at the launch station.

10. The method of claim 8, further comprising transmitting data from an airborne vehicle at the launch station to the host station.

11. A telemetry acquisition system, comprising:
a host station; and
a point of acquisition capable of:
acquiring telemetry data from the airborne vehicle;
processing the acquired telemetry data at the point of acquisition; and
transmitting the processed telemetry data to the host station.

12. The telemetry acquisition system of claim 11, wherein the point of acquisition comprises launch station.

13. The telemetry acquisition system of claim 11, further comprising a network.

14. The telemetry acquisition system of claim 13, wherein:
the point of acquisition and the host station each include a common network interface; and
transmitting the processed telemetry data includes transmitting the processed telemetry data over the network through the common network interfaces.

15. The telemetry acquisition system of claim 13, wherein the point of acquisition is a launch station and the host station is capable of transmitting a command to an airborne vehicle at the launch station over the network.

16. The telemetry acquisition system of claim 13, wherein in the host station is capable of transmitting a command to the point of acquisition.

17. The telemetry acquisition system of claim 13, wherein the networked communications link employs a TDP/IP protocol.

18. The telemetry acquisition system of claim 11, wherein the host station is capable of transmitting a command to the point of acquisition.

19. The method of claim 11, wherein the point of acquisition is further capable of transmitting data from an airborne vehicle at the launch station to the host station.

20. A telemetry acquisition system, comprising:
a host station;
a plurality of telemetry acquisition stations; and
a network over which the host station and the telemetry acquisition stations communicate through a common network interface at each of the host station and the common telemetry acquisition stations.

21. The telemetry acquisition system of claim 20, wherein at least one of the telemetry acquisition stations comprises launch station.

22. The telemetry acquisition system of claim 21, wherein the host station is capable of transmitting a command to an airborne vehicle at the launch station over the network.

23. The telemetry acquisition system of claim 20, wherein in the host station is capable of transmitting a command to the telemetry acquisition station over the network.

24. The telemetry acquisition system of claim 20, wherein the telemetry acquisition stations are capable of:
acquiring telemetry data from the airborne vehicle;
processing the acquired telemetry data; and
transmitting the processed telemetry data to a host station.

25. The telemetry acquisition system of claim 20, wherein the network employs a TDP/IP protocol.

26. A method for use in acquiring telemetry regarding an airborne vehicle, comprising communicating between a telemetry data acquisition station and a host station through a common network interface.

27. The method of claim 26, wherein communicating between the host station and the telemetry data acquisition station includes communicating acquired telemetry data from the telemetry data acquisition station to the control center through a common network interface.

28. The method of claim 27, wherein at least one of the telemetry acquisition stations is a launch station and communicating between the host station and the telemetry data acquisition station includes transmitting data from an airborne vehicle at the launch station to the host station.

29. The method of claim 26, wherein communicating between the host station and the telemetry data acquisition station includes transmitting a command from the host station to one of the telemetry acquisition stations.

30. The method of claim 29, wherein at least one of the telemetry acquisition stations is a launch station and transmitting the command from the host station to one of the telemetry acquisition stats includes transmitting a command to an airborne vehicle at the launch station.

31. The method of claim 26, wherein communicating between the host station and the telemetry data acquisition station includes employs a TFP/IP protocol.

32. The method of claim 26, wherein at least one of the telemetry acquisition stations is a launch station and communicating between the host station and the telemetry data acquisition station includes transmitting data from an airborne vehicle at the launch station to the host station.

33. A TDP/IP protocol.

34. The TDP/IP protocol of claim 33, including a TDP/IP layer.

35. The TDP/IP protocol of claim 34, further including a transport layer upon which the TDP/IP layer is built.

36. The TDP/IP protocol of claim 35, wherein the transport layer is a UDP layer.
